(19) United States
(12) Patent Application Publication
(10) Pub. No.: US 2007/0085339 A1
(43) Pub. Date: Apr. 19, 2007

(54) Front loader joint

(75) Inventors: Kenichiro Tsuji, Osaka (JP); Hideaki Dozono, Osaka (JP)

Correspondence Address: THE WEBB LAW FIRM, P.C., 700 KOPPERS BUILDING, 436 SEVENTH AVENUE, PITTSBURGH, PA, 15219, US

(73) Assignee: Kubota Corporation, Osaka-shi (JP)

(21) Appl. No.: 11/516,038

(22) Filed: Sep. 5, 2006

(30) Foreign Application Priority Data
Oct. 14, 2005 (JP) PAT. 2005-300510

(51) Int. Cl. F16L 39/00

(52) U.S. Cl. 285/133.4

(57) ABSTRACT

The joint includes a duct connecting portion provided at one end side of the hydraulic joint and connected to a hydraulic duct and a passage shutting-off portion provided at the other end side of the hydraulic joint and connected to the pressure oil passage, thereby shutting off a communicating passage communicated with the pressure oil passage.

### BACKGROUND OF THE INVENTION

1. Field of the Invention

The present invention relates to a hydraulic joint to be connected to a pressure oil passage, more particularly to a hydraulic joint to be connected to a hydraulic block for taking off pressure oil to an implement such as a front loader mounted on e.g. a tractor.

2. Description of the Related Art

A conventional hydraulic joint to be connected to a pressure oil passage includes, at one end thereof, a duct connecting portion to which a hydraulic duct such as a hydraulic hose is connected and includes, at the other end thereof, a thread portion (male thread). As this thread portion is threaded with a threaded portion (female thread) formed at an end of the hydraulic duct, the hydraulic joint is connected to the hydraulic duct.

Further, the hydraulic block includes a pressure oil passage extending therethrough. A port provided at one end of this pressure oil passage is connected to a hydraulic pump via a delivery pipe. The hydraulic block further includes a communicating passage communicating with the pressure oil passage (see Japanese Utility Model Application “Kokai” No. 61-76864). With the hydraulic joint disclosed in the Japanese Utility Model Application “Kokai” No. 61-76864, when pressure oil is to flow through the communicating passage, a port provided at the other end of the pressure oil passage is closed with a plug. Whereas, when the pressure oil is to be discharged from the pressure oil passage through the port provided at the other end thereof, a hydraulic joint for connecting a hydraulic duct such as a hydraulic hose is connected to the other end port of the pressure oil passage and also the communicating passage is shut off by means of a switching valve incorporated within this communicating passage.

As described above, in the case of the conventional hydraulic joint, for discharging pressure oil from the other end port of the pressure oil passage, this requires the switching valve for shutting off the communicating passage and requires also a trouble of working for incorporating this switching valve within the hydraulic block.

Moreover, the switch-over of the communicating passage between the communicating state and the shut-off state requires an operation of the switching valve and the trouble of effecting this operation.

### SUMMARY OF THE INVENTION

In view of the above-described shortcomings, the primary object of the present invention is to provide a hydraulic joint which allows shutting off of the communicating passage without providing the switching valve.

For accomplishing the above-noted object, according to one aspect of the present invention, there is proposed a hydraulic joint to be connected to a pressure oil passage, the joint comprising:

a duct connecting portion provided at one end side of the hydraulic joint and connected to a hydraulic duct; and

a passage shutting-off portion provided at the other end side of the hydraulic joint and connected to the pressure oil passage, thereby shutting off a communicating passage communicated with the pressure oil passage.

For accomplishing the above-noted object, according to a further aspect of the present invention, there is proposed a hydraulic joint to be connected to a hydraulic block having a pair of pressure oil passages and a communicating passage communicating the pair of pressure oil passages, the joint being connected to the pressure oil passages, the hydraulic joint comprising:

a duct connecting portion provided at one end side of the hydraulic joint and connected to a hydraulic duct; and

a passage shutting-off portion provided at the other end side of the hydraulic joint and connected to the pressure oil passage, thereby shutting off a communicating passage communicated with the pressure oil passage.

For accomplishing the above-noted object, according to a still further aspect of the present invention, there is proposed a hydraulic joint to be connected to a hydraulic block having a first pressure oil passage for introducing, from one end thereof, pressure oil from a hydraulic pump and discharging, from the other end thereof, the pressure oil to an implement, a second pressure oil passage for introducing, from one end thereof, the pressure oil from the implement and discharging the pressure oil from the other end thereof, and a communicating passage communicating the first pressure oil passage and the second oil passage, the hydraulic joint comprising:

a duct connecting portion provided at one end side of the hydraulic joint for feeding the pressure oil to the implement; and

a passage shutting-off portion provided at the other end side of the hydraulic joint, the passage shutting-off portion being inserted from the implement side of the first or second pressure oil passage, thereby shutting off said communicating passage.

Preferably, the hydraulic joint further comprises a sealing portion provided closer to the other end side than said passage shutting-off portion, the sealing portion sealing between an outer peripheral face of the other end side of the hydraulic joint and an inner face of the pressure oil passage.

Still preferably, the hydraulic joint further comprises a thread portion provided between said duct connecting portion and said passage shutting-off portion and threaded with a threaded portion formed on the end side of the pressure oil passage, thereby fixedly attaching the hydraulic joint.

When the hydraulic joint of the invention is connected to the pressure oil passage, the communicating passage communicated with this pressure oil passage can be shut off by the passage shutting-off portion provided in the hydraulic joint.

### BRIEF DESCRIPTION OF THE DRAWINGS

FIG. 1 is a plan view in section showing a hydraulic block when a hydraulic joint of the invention is attached thereto,

FIG. 2 a plan view in section showing the hydraulic block when the hydraulic joint of the invention is not attached thereto,

FIG. 3 is a side view of a traveling work vehicle, and

FIG. 4 is a side view of a body of a tractor.

### DESCRIPTION OF THE PREFERRED EMBODIMENTS

Next, preferred embodiments of the present invention will be described with reference to the accompanying drawings.

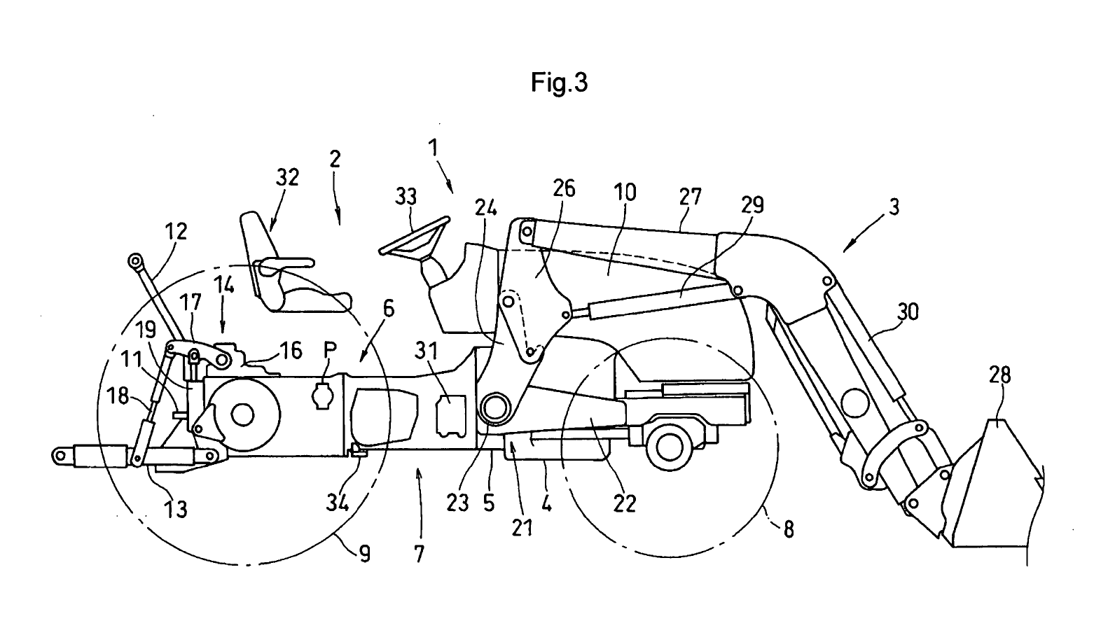

In FIG. 3, numeral 1 denotes a traveling work vehicle. This traveling work vehicle 1 includes a tractor 2 as a traveling vehicle and a front loader 3 mounted on the tractor 2. The front loader 3 is an example of an implement (front-mounted implement) having a hydraulic actuator. The front loader 3 is detachably mounted to the front portion of the tractor 2.

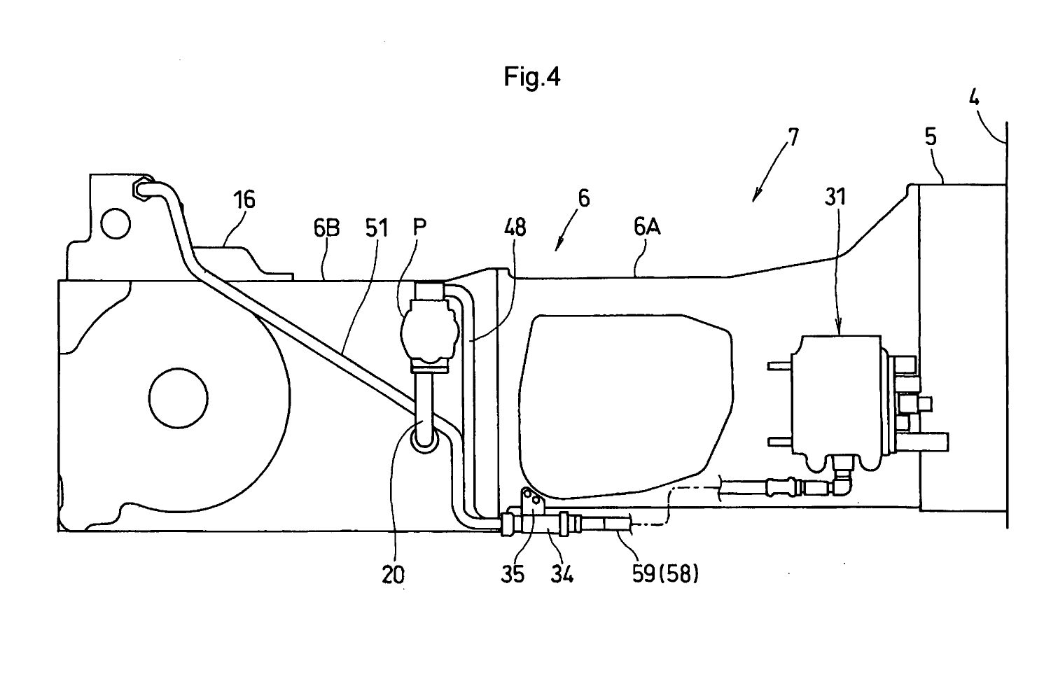

As shown in FIG. 3 and FIG. 4, the tractor 2 includes a vehicle body 7 which has, as principal components thereof, an engine 4, a flywheel housing 5 connected to the rear side of the engine 4 and a transmission case 6 connected to the rear side of the flywheel housing 5. This tractor 2 is a two-shafts, four-wheeled tractor having the vehicle body 7 thereof supported by right and left pairs of front and rear wheels 8, 9. The engine 4 is covered with a hood 10. The transmission case 6 accommodates, therein a traveling power transmission mechanism for transporting power from the engine 4 at least to the rear wheels 9 via a clutch, a transmission unit, differential units, etc. and a PTO power transmission mechanism for transmitting the power of the engine 4 to a PTO shaft 11 protruding from a rear face of the vehicle body 7.

The transmission case 6 is divided into a front case 6A and a rear case 6B. At the rear of the vehicle body 7 of the tractor 2, a rear implement such as a rotary tiller, plow or the like can be attached to be lifted up/down, via a three-point link mechanism having an upper single top link 12 and a pair of lower right and left lower links 13. Further, on the rear side of the vehicle body 7, there is provided a hydraulic lift device 14 is provided for lifting up/down the rear implement.

This hydraulic lift device 14 includes, as principal components thereof, a mounting body 16 fixedly attached to a rear upper side of the transmission case 6, a pair of right and left lift arms 17 attached to right and left opposed sides of the mounting body 16 to be vertically pivotable about a right/left axis, a pair of right and left lift rods 18 for connecting the right and left lift arms 17 with the lower links 13 on the same right/left sides, and a pair of right and left lift cylinders 19 for vertically pivoting the lift arms 17.

With this hydraulic lift device 14 in operation, as the right and left lift cylinders 19 are expanded or retracted (projection/retraction of piston rods thereof, the right and left lift arms 17 are vertically pivoted about the respective pivot axes. And, in association with the vertical pivotal movements of the right and left lift arms 17, the right and left lower links 13 are vertically pivoted about the pivots provided in the tractor 2, whereby the rear implement is lifted up/down.

Further, the lift cylinder 19 is constructed as a single-action hydraulic cylinder. In operation, as this lift cylinder 19 feeds pressure oil to a piston top of the cylinder body of the lift cylinder 19, the rear implement is lifted up. Whereas, as the pressure oil present at the piston top of the cylinder body of the lift cylinder 19 is discharged, the rear implement is lowered by the weight of its own. Further, when the feeding or discharging of the pressure oil to/from the lift cylinder 19 is stopped, the lift arm 17 is stopped, thus stopping the rear implement.

Incidentally, the hydraulic lift device 14 can comprise a modified single-action type hydraulic cylinder having a piston housed within a cylinder block fixedly attached to the rear upper face of the transmission case 6 and supporting the lift arm 17.

At an upper portion on the left side and fore-and-aft intermediate portion of the transmission case 6, there is provided a hydraulic pump P driven by the power from the engine 4. In the present embodiment, this hydraulic pump P is constructed as a double pump comprised of an assembly of two gear pumps and this pump P is driven by power taken off from a portion before a PTO clutch of the PTO power transmission mechanism. In operation, lubricant oil, as a working oil, reserved within the transmission case 6 is taken into the hydraulic pump P via a suction pipe 20, and the pressure oil discharged from one discharge port of this hydraulic pump P is fed to e.g. the hydraulic lift device 14, whereas the pressure oil discharged from the other discharge port of the pump is fed to a hydraulic device such as a power-steering controller.

The front loader 3 is detachably attached to a mounting frame 21 mounted to the front of the tractor 2.

In the present embodiment, the mounting frame 21 includes, on right and left opposed sides of the vehicle body 7, a connecting plate 22 fixedly attached to the right and left opposed sides of the front portion of the vehicle body 7, a cylindrical support deck 23 fixed to the connecting plate 22 to project outwardly therefrom in the right/left direction, and a pair of right and left main frames 24 fixed to the support deck 23 to project upward therefrom.

The front loader 3 includes a pair of right and left side frames 26 detachably attached to the right and left respective main frames 24, a pair of right and left booms 27 connected to the upper portions of the right and left side frames 26 to be pivotable about a right/left axis, a bucket 28 connected to the leading ends of the right and left booms 27 to be pivotable about a right/left axis, a boom cylinder 29 for vertically pivoting the right and left respective booms 27 about the pivot and a bucket cylinder 30 for pivoting the bucket 28 for effecting a scooping/dumping action. Both the boom cylinder 29 and the bucket cylinder 30 comprise hydraulic cylinders.

At a right front portion of the vehicle body 7 (right front portion of the transmission case 6), there is disposed a control valve 31 for controlling the boom cylinder 29 and the bucket cylinder 30 of the front loader 3, with the valve 31 being fixed to the vehicle body 7. This control valve 31 is remotely operable by a control lever provided adjacent a driver's seat 3 or a steering wheel 33.

Incidentally, the control valve 31 can be adapted to be directly operable by the control lever.

In this tractor 2, in the course of an oil path extending from the hydraulic pump P to the hydraulic lift device 14 for lifting up/down the rear implement, there is provided a hydraulic block 34 for taking off the pressure oil for the front loader 3.

This hydraulic block 34 is constructed as a rectangular solid body and is disposed forwardly of the hydraulic pump P on the right side of the transmission case 6 and also downwardly of this transmission case 6. As a bracket 35 fixed to the upper side of the hydraulic block 34 is bolt-fixed to an attaching boss provided in the transmission case 6, the hydraulic block 34 is fixedly attached to the vehicle body 7.

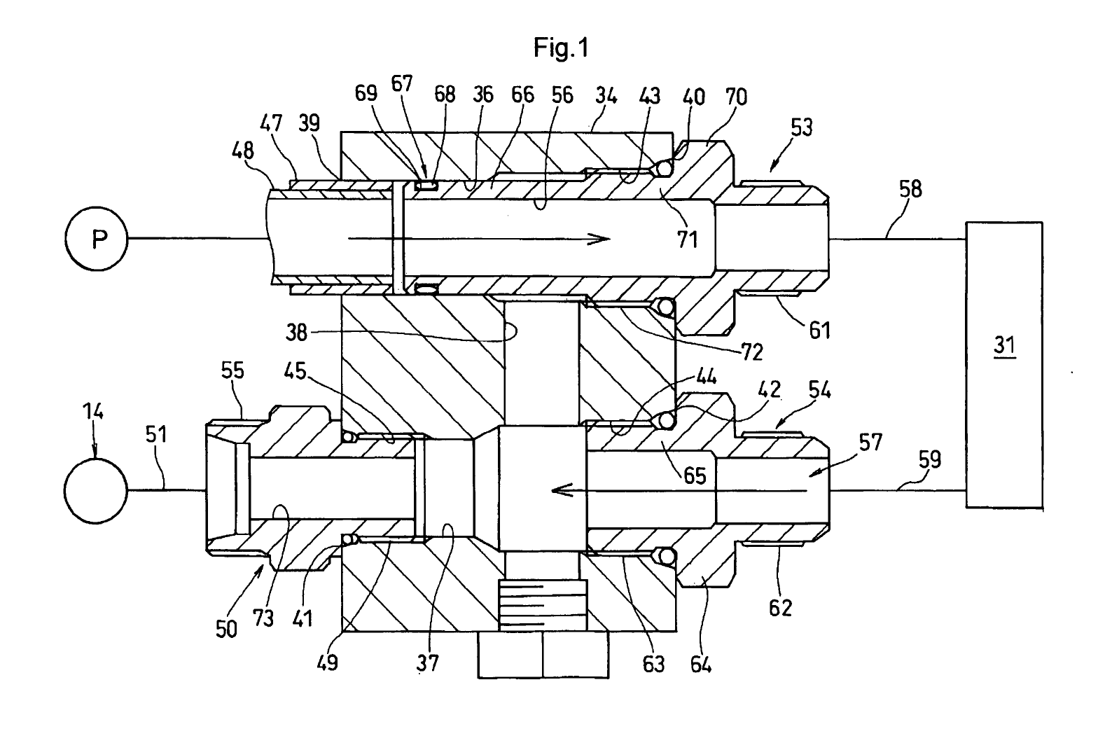

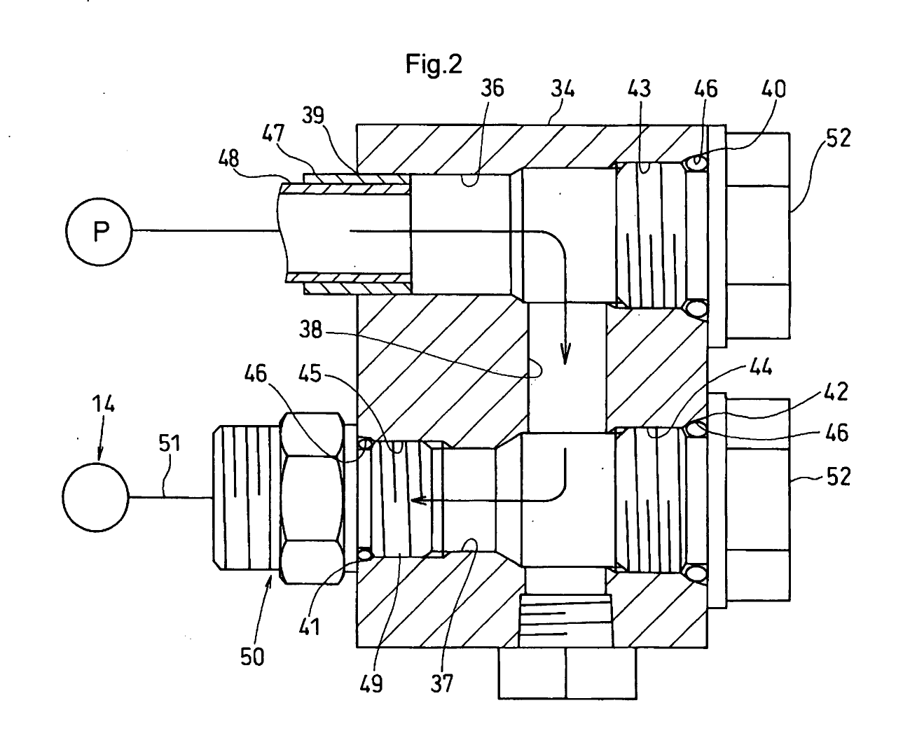

As shown in FIG. 1 and FIG. 2, this hydraulic block 34 includes a pair of right and left pressure oil passages 36,37 extending through the hydraulic block 34 linearly along the fore-and-aft direction and a communicating passage 38 communicating these pressure oil passages 36, 37 with each other at fore-and-aft intermediate portions thereof (hereinafter, the left side pressure oil passage will be referred to as the first pressure oil passage 36, whereas the right side pressure oil passage will be referred to as the second pressure oil passage 37, respectively).

The first pressure oil passage 36 and the second pressure oil passage 37 are formed parallel with each other in the right/left direction. And, the communicating passage 38 communicates perpendicularly these first and second pressure oil passages 37, 38. The rear end side of the first pressure oil passage 36 is provided as a pump port 39 for introducing the pressure oil from the hydraulic pump P and the front end side of this first pressure oil passage 36 is provided as an out-port 40 (this will be referred as the first out-port) for discharging the pressure oil to be fed to the front loader 3.

The rear end side of the second pressure oil passage 37 is provided as an out-port 41 (this will be referred to as the second out-port) for discharging the pressure oil to be fed to the hydraulic lift device 14 for lifting up/down the implement and the front end side of the second pressure oil passage 37 is provided as an in-port 42 for introducing the pressure oil returned from the front loader 3.

Each of the first and second pressure oil passages 36, 37 has an increased diameter at the fore-and-aft intermediate portion communicated with the communicating passage 38, relative to a rear portion of the passage. On the front sides of the first and second pressure oil passages 36, 37 forwardly of the front side communicating passage 38 and on the rear side of the second pressure oil passage 37, there are respectively formed threaded portions 43, 44, 45 (female threads). On the sides of the first out-port 40, the second out-port 41 and the in-port 42 of the first and second pressure oil passages 36, 37, there are provided seal engaging portions 46 within which sealing members (0-rings) are to be fitted.

To the rear end of the first pressure oil passage 36, a connecting cylinder 47 inserted through the pump port 39 is fixed by welding or the like. To this connecting cylinder 47, one end side of a delivery pipe 48 is affixed. The other end side of the delivery pipe 48 is connected to the discharge opening of the pump port 39, so that the delivery pipe 48 communicates the pump port 39 side of the first pressure oil passage 36 with the discharge opening of the hydraulic pump P.

Further, at the rear end side of the second pressure oil passage 37, there is connected a hydraulic joint 50 having a thread portion 49 (male thread) to be threaded with the threaded portion 45 of the first out-port 40 side of this second pressure oil passage 37. To a duct connecting portion 55 (male thread) of this hydraulic joint 50, there is connected one end of a hydraulic duct 51 comprised of e.g. a hydraulic pipe. The other end of the hydraulic duct or pipe 51 is connected to a pressure oil inlet of the mounting body 16 of the implement lifting hydraulic lift cylinder 19, so that the pressure oil is fed from the mounting body 16 via a control valve or the like to the lift cylinder 19 or fed from the control valve into the transmission case 6. With the hydraulic block 34 having the above-described construction, when the front loader 3 is not to be mounted, as shown in FIG. 2, the first out-port 40 and the in-port 42 (the front end sides of the first and second pressure oil passages 36, 37) are closed by plugs 52 threaded and fitted on the threaded portions 43, 44 provided at the front end sides of the first and second pressure oil passages 36, 37. So that, the pressure oil from the hydraulic pump P is introduced from the pump port 39 side into the first pressure oil passage 36 and flows through the communicating passage 38 into the second pressure oil passage 37 and then flows out of a pressure oil communicating hole 73 of the hydraulic joint 50 on the second out-port 41 side of the second pressure oil passage 37 toward the hydraulic lift device 14.

On the other hand, when the front loader 3 is to be mounted, the plugs 52 are removed from the first out-port 40 side and the in-port 42 side of the first and second pressure oil passages 36, 37 and as shown in FIG. 1, hydraulic joints 53, 54 are connected respectively to the first out-port 40 side of the first pressure oil passage 36 and the in-port side 42 of the second pressure oil passage 37 (hereinafter, the hydraulic joint 53 connected to the first out-port 440 side of the first pressure oil passage 36 will be referred to as the out-side joint, whereas the hydraulic joint 54 connected to the in-port 42 side of the second pressure oil passage 37 will be referred to as the in-side joint, respectively).

The out-side joint 53 and the in-side joint 54 respectively define pressure communicating holes 56, 57 extending therethrough along the axial direction. Further, on the outer peripheral portions on one axial end side, there are formed duct connecting portions 61, 62 (male threads) to which one end portions of hydraulic ducts 58, 59 (e.g. hydraulic hoses) for feeding the pressure oil to the front loader 3 side are connected via the joints and the other end sides of the hydraulic ducts 58, 59 are connected to the control valve 31.

On the outer peripheral portion of the other axial end side of the in-side joint 54, there is formed a thread portion 63 (male thread) to be threaded with the threaded portion 44 of the in-port 42 side of the second pressure oil passage 37, and on the outer peripheral portion at the axial intermediate portion, there is provided a tool engaging portion 64 provided in the form of a hexagonal cylinder for engagement with a tool. Between this tool engaging portion 64 and the thread portion 63, there is provided a seal engaging portion 65 on which an O-ring (seal) is to be fitted. Then, as the thread portion 63 is threaded into the threaded portion 44 of the in-port 42 side, the in-port side joint 54 is connected to the in-port 42 side of the second pressure oil passage 37.

Also, on the outer periphery of the axial other end side of the out-side joint 53, there is provided a passage shutting-off portion 66 which is inserted from the first out-port 40 into the first pressure oil passage 36, thereby shutting off the pressure communication of the communicating passage 38. On the more leading end side (rear end side) of this passage shutting-off portion 66, there is provided a sealing portion 67 for sealing between the other end side outer peripheral face of the out-side joint 53 and the inner face of the first pressure oil passage 36. This sealing portion 67 consists of a sealing member (O-ring) and an engaging groove 68 into which the sealing member 68 is fitted.

Further, at an outer peripheral portion of axially intermediate portion of this out-side joint 53, like the in-side joint 54 described above, there are formed a tool engaging portion 70, a seal engaging portion 71 and a thread portion 72 in the mentioned order from one axial end side to the other axial end side (from the front end side to the rear end side). Then, as the other end side of this out-side joint 53 is inserted via the first out-port 40 into the first pressure oil passage 36 and the thread portion 72 is threaded into the threaded portion 43 of the first out-port 40 side, the out-side joint 53 is connected to the first out-port 40 side of the first pressure oil passage 36 and also the pressure oil communication in the communicating passage 38 is shut off by the passage shutting-off portion 66.

With the above-described construction, when the front loader 3 is mounted, the pressure oil communication of the communicating passage 38 is shut off, i.e. blocked, by the out-side joint 53. Therefore, the pressure oil from the hydraulic pump P introduced from the pump port 39 side flows through the pressure oil communicating hole 56 of the out-side joint 53 and flows also through the feeding side hydraulic duct 58 connected to this out-side joint 53. Whereas, the pressure oil returned from the control valve 31 flows through the return-side hydraulic duct 59 and flows also through the pressure oil communicating hole 59 of the in-side joint 54 into the second pressure oil passage 37, and then flows out of the second out-port 41 side of this second pressure oil passage 37 toward the hydraulic lift device 14.

Incidentally, in the above-described construction, the out-side joint 53 can have the same construction as the in-side joint 54 illustrated in the figures and the in-side joint 64 can have the same construction as the out-side joint 43 shown in the figures. Further alternatively, both the out-side joint 53 and the in-side joint 44 can have the same construction as that of the out-side joint 53 illustrated and exemplified above.

Further, when the front loader 3 is mounted, the hydraulic joint 50 connected to the second out-port 41 side of the second pressure oil passage 37 can be replaced by a joint having the construction capable of shutting off the communicating passage 38 (i.e. a hydraulic joint having the above-described passage shutting-off portion).

Moreover, to the pump port 39 side of the first pressure oil passage 36, there may be connected a hydraulic joint for connecting the delivery pipe 48 for feeding the pressure oil from the hydraulic pump P. And, there can be prepared two kinds of such hydraulic joints, one not shutting off the communicating passage 38, the other shutting off the communicating passage 38. So that, when the front loader 3 is to be mounted, the latter type of the hydraulic joint capable of shutting off the communicating passage 38 may be used instead.

That is to say, the passage shutting-off portion for shutting off the communicating passage 38 may be provided in the hydraulic joint to be connected to either end side of the pressure oil passages 36, 37.

Moreover, the hydraulic joint of the invention is not limited to the above-described joint which is configured to be connected to the hydraulic block 34 for taking off the pressure oil for the front loader 3. Instead, this joint can be employed in any construction which needs to selectively provide a communicating state and a blocked state of a communicating passage communicated with pressure oil passages.

1. A hydraulic joint to be connected to a pressure oil passage, the joint comprising:
a duct connecting portion provided at one end side of the hydraulic joint and connected to a hydraulic duct; and
a passage shutting-off portion provided at the other end side of the hydraulic joint and connected to the pressure oil passage, thereby shutting off a communicating passage communicated with the pressure oil passage.

2. A hydraulic joint to be connected to a hydraulic block having a pair of pressure oil passages and a communicating passage communicating the pair of pressure oil passages, the joint being connected to the pressure oil passages, the hydraulic joint comprising:
a duct connecting portion provided at one end side of the hydraulic joint and connected to a hydraulic duct; and
a passage shutting-off portion provided at the other end side of the hydraulic joint and connected to the pressure oil passage, thereby shutting off a communicating passage communicated with the pressure oil passage.

3. A hydraulic joint to be connected to a hydraulic block having a first pressure oil passage for introducing, from one end thereof, pressure oil from a hydraulic pump and discharging, from the other end thereof, the pressure oil to an implement, a second pressure oil passage for introducing, from one end thereof, the pressure oil from the implement and discharging the pressure oil from the other end thereof, and a communicating passage communicating the first pressure oil passage and the second oil passage, the hydraulic joint comprising:
a duct connecting portion provided at one end side of the hydraulic joint for feeding the pressure oil to the implement; and
a passage shutting-off portion provided at the other end side of the hydraulic joint, the passage shutting-off portion being inserted from the implement side of the first or second pressure oil passage, thereby shutting off said communicating passage.

4. The hydraulic joint according to claim 1, further comprising a sealing portion provided closer to the other end side than said passage shutting-off portion, the sealing portion sealing between an outer peripheral face of the other end side of the hydraulic joint and an inner face of the pressure oil passage.

5. The hydraulic joint according to claim 2, further comprising a sealing portion provided closer to the other end side than said passage shutting-off portion, the sealing portion sealing between an outer peripheral face of the other end side of the hydraulic joint and an inner face of the pressure oil passage.

6. The hydraulic joint according to claim 3, further comprising a sealing portion provided closer to the other end side than said passage shutting-off portion, the sealing portion sealing between an outer peripheral face of the other end side of the hydraulic joint and an inner face of the pressure oil passage.

7. The hydraulic joint according to claim 1, further comprising a thread portion provided between said duct connecting portion and said passage shutting-off portion and threaded with a threaded portion formed on the end side of the pressure oil passage, thereby fixedly attaching the hydraulic joint.

8. The hydraulic joint according to claim 2, further comprising a thread portion provided between said duct connecting portion and said passage shutting-off portion and threaded with a threaded portion formed on the end side of the pressure oil passage, thereby fixedly attaching the hydraulic joint.

9. The hydraulic joint according to claim 3, further comprising a thread portion provided between said duct connecting portion and said passage shutting-off portion and threaded with a threaded portion formed on the end side of the pressure oil passage, thereby fixedly attaching the hydraulic joint.
